(19) United States
(12) Patent Application Publication
(10) Pub. No.: US 2011/0199987 A1
(43) Pub. Date: Aug. 18, 2011

(54) Multi-PDN (Packet Data Network) Connectivity To One APN (Access Point Name)

(76) Inventors: Stefan Rommer, Vastra Frolunda (SE); Johan Sörensen, Eslov (SE)

(21) Appl. No.: 12/808,596

(22) PCT Filed: Dec. 15, 2008
(86) PCT No.: PCT/EP2008/067544

§ 371 Date: Jun. 16, 2010

Related U.S. Application Data
(60) Provisional application No. 61/016,858, filed on Dec. 27, 2007.

(51) Int. Cl. H04W 72/04

(52) U.S. Cl. 370/329

(57) ABSTRACT

The present invention relates to a solution for handling several Packet Data Network (PDN) connections in a relation to one access point name, i.e. APN in a communication network, e.g. evolved packet system, i.e. EPS using a solution for appending a tag to an APN with a unique identifier and optionally a tag divisor.

### TECHNICAL FIELD

The present invention relates to a solution for handling several primary packet data network connections towards one access point name in a telecommunications network.

### BACKGROUND

The current evolution of telecommunication solutions, the concept of packet based communication in a wireless environment is widely finding acceptance. The 3GPP group is currently working on Release 8 of its standardization of communication protocol, which introduces a new radio access technology (E-UTRAN, aka LTE (Long Term Evolution)), together with a new architecture for the IP core- and service network; the Enhanced Packet System (EPS). The latter work is also known as the System Architecture Evolution (SAE). This work also includes provisions to connect non-3GPP access technologies with the EPS.

In 3GPP TS 23.401 (V8.0.0) and TS 23.402 (V8.0.0) there are concepts and procedures to support User Equipment (UE) connectivity to a default Packet Data Network (PDN), meaning that an Access Point Name (APN) is provided by the Home Subscriber System (HSS) or the UE at initial attach, and to allow the UE to establish additional PDN connections towards APNs provided by the UE.

The types of terminals that this explicitly applies to are:
An “integrated” UE, i.e. the cellular radio and the application processor hosting the IP stack and applications are tightly integrated in one device, e.g. a mobile phone.
A “split” UE, i.e. cellular radio is not tightly integrated with the device hosting the IP stack and applications, e.g. a laptop with a plug-in card.

One scenario for which there are no explicit provisions in the standards documents is this case:

Using an “integrated” UE as an access point from another device, or “terminal equipment” (TE) (e.g. PDA or laptop) that does not contain the desired access technology itself.

Using a mobile phone as an access point from an external TE (Terminal Equipment), over e.g. IrDA, Bluetooth, UST, or similar Focal connectivity technologies, might at first glance be seen as a special case of a “split UE”.

The TE (e.g. laptop) uses standard IP parameter assignment methods towards the UE, depending on the type of the local connection; for example, DHCP over links emulating Ethernet, or PCP when using PPP.

However, this is not trivial if the end user wants to use an application in the UE (i.e. mobile phone) that requires Internet Protocol (IP) connectivity at the same time as IP connectivity is provided for a TE. This will be a common scenario for UE:s supporting Packet Switched (PS) only technologies like E-UTRAN.

When using IP connectivity from a TE that is connected to a network via an “integrated” UE, what APN might be used for the TE? In current 3GPP network/service deployments, operators sometime require certain services to use special APNs. But except for special cases where the TE user wishes to gain access to some very special APN, e.g. representing a corporate network, it can be expected that the TE user is happy as long as the APN provides Internet connectivity. In EPS terms, giving the TE access to the default PDN should be the normal case.

To summarize the APN discussion, in the normal case, it can be expected that PDN connectivity for TE(s) is made using the same APN as the default one being used in the UE itself.

This means that there has to be a way to either share one PDN connection from the UE, or to set up multiple PDN connections to the same APN, in order to give IP connectivity to a TE.

### PROBLEMS WITH EXISTING SOLUTIONS

The PDP context concept and procedures as defined before Release 8 allows multiple “primary” contexts with no restriction regarding which APN is used, i.e., the same APN can be used for multiple contexts. This allows the UE to instantiate one PDP context for its own IP connectivity, then another PDP context when a TE wants IP connectivity. The PDN connectivity service as defined for the PPS does currently have the same feature when the PDN Connectivity service is provided using GTP. Note that in earlier 3GPP releases, and for GERAN/UTRAN in Release 8, there is the PDP context concept, which corresponds closely to the PDN connection concept in the EPS. The PDN connectivity service as defined for the EPS when PMIP is used does not currently have the same flexibility, i.e. multiple PDN connections can be established, but only towards different APNs. One reason is that the APN together with the UE identity is currently used as a session identifier in different network entities:
For PMIP-based interfaces, the PDN GW treats each combination of {UE ID, APN} as a separate connection and will assign a new IP address to each connection.
The PCC architecture for the RAW-based architecture use in certain scenarios the {UE ID, APN}-tuple as an identifier for a session.

If there are multiple PDN connections to the same APN, the 2-tuple {UE ID, APN} cannot be used to unambiguously identify a PDN connection.

Possible existing, or alternative, solutions are:

1. One possible solution is to implement NAT router functionality in the UE. This would allow one PDN connection to be shared, by having the UE allocate a private IP address to external TE(s), and then through Network Address Translation/Protocol Translation make TCP/UDP/IP traffic from the TE appear to come from the UP as seen by the network.

Why is NAT routing in the UE undesirable?
UE complexity—NAT in itself is not trivial, and conies with list of Application Layer Gateways (ALGs) to handle NAT traversal for a set of IP applications that otherwise break.
IP transmission throughput is likely to be degraded, and UP battery consumption will be negatively affected by increased processing load.
End user impact—where ever there is a NAT, there is usually a management interface to configure NAT options (e.g. mapping external ports to ports on internal IP-address/port pairs).

As a complement the UE will likely need to support the UPnP profile for IP Gateways (to allow PC applications to configure the NAT automatically)—with additional complexity impact.

2. Another possible solution is to amend the EPS standards to allow multiple PDN connections regardless of APN also when PMIP is used.

This would require updates in 3GPP specifications for PMIP-based S5/S8 for 3GPP accesses. In order to provide support for multiple PDN connections to the same APN also when the UE is using non-3GPP accesses, similar updates would be needed for MOP based S2a/S2b interfaces. Thus, fixing the problem in the core should be possible, but with some effort, and with impact on several nodes in the EPS.

To conclude, it is desirable to avoid NAT routing in UEs, and to keep backward compatibility with the PDP context capabilities before 3GPP Release 8.

### SUMMARY

It is an object of the present invention to provide a solution for multiple PDN connections while at the same time reducing the problems with the existing solutions mentioned above.

The present invention introduces a tag in an APN string when activating additional PDN connections. This tagging is proposed to be done by appending an identifier, e.g. a semicolon and a sequence number, to the original APN string. The tagging can either be done by the UE when requesting the additional PDN connection or by an entity in the NW, e.g. an access gateway.

This is provided in a number of aspects of the present invention, in which a first is a communication node for providing several Packet Data Network (PDN) connections towards one Access Point Name, i.e. APN, in a telecommunications network. The communication node comprises a processor, a memory, and a communication interface for communication with the telecommunications network, wherein the processor is arranged to execute instructions stored in the memory for inserting a tag, associated with a PDN connection, in an access point name string transmitted over the network in an Internet Protocol based communication link and where the tag is arranged to uniquely distinguish the connection from other PDN connections.

The node may be one of a user equipment (UE), a radio network node, or a core network node. The tag may comprise a divisor and a unique string of characters; the divisor may comprise a semicolon and the unique string of characters may comprise a sequence number.

The radio network node may be arranged to receive a new PDN connection request from a UE and to tag the APN in relation to receiving the new PDN connection request or the UE may be arranged to insert the tag in relation to sending a request for a new PDN connection setup.

Another aspect of the present invention is provided, a method for providing several Packet Data Network (PDN) connections associated with one Access Point Name (APN) in a telecommunications network, comprising the steps of:

including in an APN message a tag for each PDN connection, distinguishing each connection from other PDN connections in an Internet Protocol based communication link, where the tag is arranged to comprise a unique identifier.

Yet another aspect of the present invention is provided, a system handling a plurality of packet data connections in a telecommunications network, composing:
a communication device according to the first aspect of the present invention;
at least one terminal equipment in communication with the communication device on the at least one communication interface;
   wherein the communication device is arranged to execute instructions stored in a memory for inserting a tag in an access point name string, associated with an established PDN connection, transmitted over the network in an Internet Protocol based communication Ink and where the tag is arranged to uniquely distinguish the connection from other PDN connections.

Furthermore, an infrastructure node is provided in a telecommunications network, comprising
a processor;
a memory;
a communication interface for communication with the telecommunications network;
   wherein the processor is arranged to execute instructions stored in the memory for extracting a unique tag in an access point name, i.e. APN, string, associated with a Packet Data Network connection, transmitted over the network in an Internet Protocol based communication link received on the communication interface and where the tag is arranged to distinguish a specific connection from a plurality of Packet Data Network connections associated with the APN.

This and other aspects of the invention will be apparent from and elucidated with reference to the embodiments described hereinafter.

### BRIEF DESCRIPTION OF THE DRAWINGS

In the following the invention will be described in a nor-limiting way and in more detail with reference to exemplary embodiments illustrated in the enclosed drawings, in which:

FIG. 1 illustrates schematically an embodiment of a network system according to the present invention;

FIGS. 2A and B illustrates schematically nodes according to the present invention;

FIG. 3 illustrates schematically in a block diagram a method according to the present invention;

FIG. 4 illustrates schematically a system according to the present invention; and

FIG. 5 illustrates schematically a communication device according to the present invention.

### DETAILED DESCRIPTION

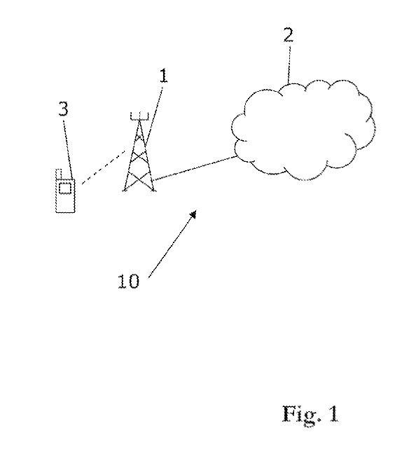

In FIG. 1 reference numeral 10 generally indicate a network according to the present invention, comprising at least one base station 1 or similar wireless access gateway (e.g. access point) to an infrastructure communication network 2. The base station 1 is arranged to communicate with user equipment 3 (UE) wirelessly and with an infrastructure network 2. The base station 2 may comprise one antenna or a plurality of antennas. The core infrastructure communication network 2 comprises several different entities depending on communication protocol.

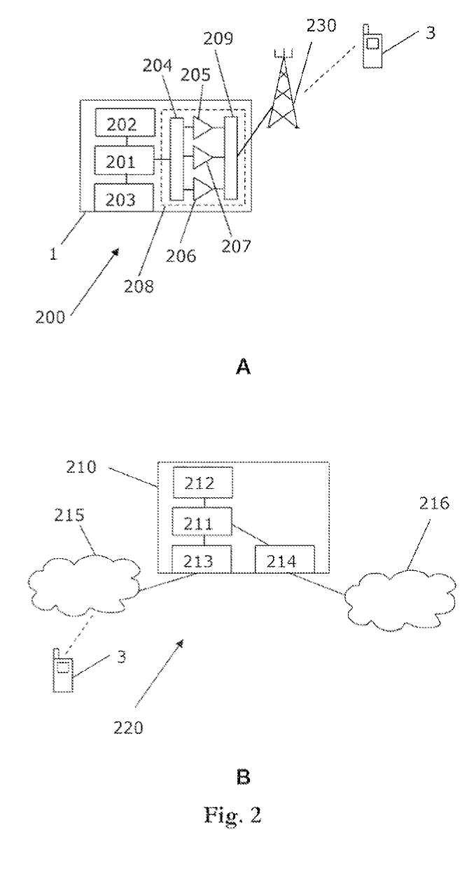

In FIG. 2A a node device 1 (e.g. a base station) implementing the solution according to the present invention is shown. The device may comprise at least one processing unit 201, at least one memory unit 202, and at least one communication interface 203. Furthermore, the device comprises a transceiver portion 208 for receiving and transmitting radio signals via an antenna 230. The transceiver portion may comprise AD/DA unit(s) 204, at least one power amplifier 205, 206, 207, and optionally a switch/multiplexer 209. The processing unit is arranged to run code for communication control and data traffic. The processing unit 201 may comprise for instance a microprocessor, a Digital Signal Processor (DSP), ASIC (application Specific Integrated Circuit), or an FPGA (Field programmable gate array) or a combination of these. The memory unit 202 may comprise any suitable type of memory (volatile and/or non-volatile) such as e.g. RAM, ROM, EEPROM, Flash, and hard disk. The communication interface 203 connects the device 1 to the infrastructure network 2 (See FIG. 1). Other communication equipment may be present as well depending on the type of wireless communication protocol/standard used. However, the RAN device may comprise any other node part of the RAN where it is suitable to implement the solution according to the present invention, e.g. RNC, BTS, BSC, or eNodeB.

It should be noted that the transceiver portion 208 may be configured in different ways depending on radio technology and/or communication protocol used as understood by the skilled person.

FIG. 28 shows a second embodiment of a network 220 according to the present invention comprising an infrastructure node 210 part of a core infrastructure network implementing the solution according to the present invention. The node 210 may comprise a processing unit 211 controlling communication data (control and/or user plane communication data). The node 210 further comprise at least one memory unit (volatile and/or non-volatile) 212 as understood by the skilled person and at least one communication interface 213, 214. For example, the communication interface may comprise one access interface 213 to an access network 215 (i.e. downstream towards the UE 3) and one infrastructure network interface 214 (i.e. upstream away from the UE) towards an infrastructure network 216 (e.g. the Internet or other communication networks). It should be noted that the access network interface and infrastructure network interface may be using the same physical communication interface (e.g. Ethernet. ATM, or similar communication interface). The infrastructure node may comprise an access gateway, an SGSN, a GGSN, or a separate entity located in the core network.

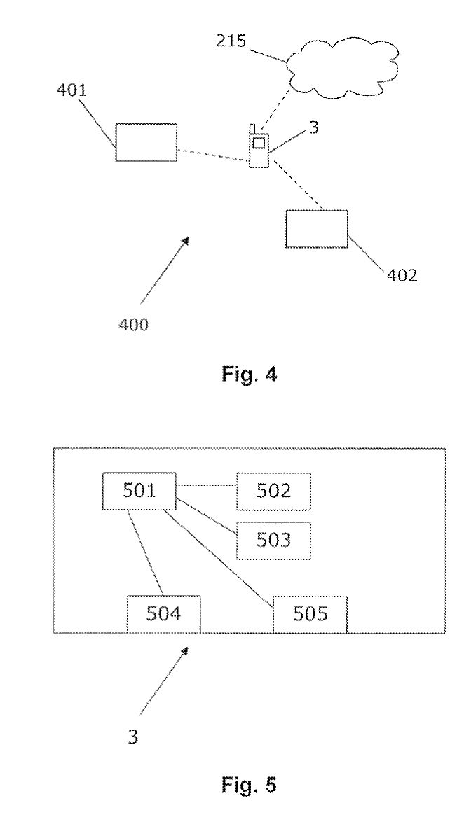

FIG. 4 illustrates a system 400 with a communication device, such as a mobile phone 3 or similar device, with a wireless communication interface towards an infrastructure network 215. In one embodiment of the present invention, at least one terminal equipment (TE) 401, 402 is connected to the communication device 3 using any suitable local communication interface. The local communication interface may be either wired or wireless. In accordance with the configuration of the present invention, the TE may be requesting an IP connection to the infrastructure network via the communication device 3 and thus a packed data network (PDN) connection is to be established; however, in order to provide a solution for multiple PDN connections, the present invention bypass the problem that multiple PDN connections with the same Access Point Name (ARM) is not supported on certain reference points in the Evolved Packet System (EPS), by tagging an APN string when activating additional PDN connections. The tagging may either be done by the communication device, e.g. UE 3 when requesting the additional PDN connection or by an infrastructure entity in the network, NW 215. The TE 401, 402 may be connected to the communication device 3 using one or several suitable communication protocols/methods such as for instance Bluetooth, Wireless Local Area network (WLAN). USB, IrDA, PCMCIA, RS-232, SRI (Serial Peripheral Interface), and so on.

In one other embodiment the communication device 3 is not connected to a number of TE but there are a number of separate applications running in the communication device that each requests a separate connection to the infrastructure network, thus potentially requesting several PDN connections from the same communication device 3.

FIG. 5 illustrates a communication device 3 according to the present invention with a processing unit 501 operating instruction sets stored in a memory 502 (volatile or non-volatile). The processing unit communicates with the infrastructure network 215 using a wireless access network interface 504 and with optional terminal equipment as shown in relation to FIG. 4 with a local communication interface 505 (wired or wireless). The communication device may also comprise a user interface 503.

In one embodiment the tagging may be done by appending a divisor character, e.g. a semicolon, and a unique identity, e.g. a sequence number, to the original APN string. The tagging may be formatted in many different ways, as long as it is possible for the UE and NW entities to uniquely separate the tagging from the rest of the APN. The tag format is preferably standardized to allow interoperability between UEs and NW entities from different vendors. Thus, over reference points where PDN connections are identified by UE identity and APN (only), multiple PDN connections to the same actual APN may be disambiguated by the tagging of the APN string. Nodes that need to understand the APN (e.g. for routing/lookup purposes) can easily strip away the tag.

The tagging is preferably done by an entity that has knowledge of all active PDN connections for a given UE. For instance, the UE itself may do the tagging. When the UE wants to request a new PDN connection to an APN where there already is an active PDN connection, the UE tags the APN with a new unique identity identifying the connection, e.g. a sequence number.

In another embodiment, an access GW, e.g. MME, SGSN, S-GW (Serving Gateway), ePDG (evolved Packet Data Gateway) or non-3GPP GW, does the tagging. Since the access GW knows about all active PDN connections for a given UE it may tag the APN appropriately when a new PDN connection request is received from the UE.

According to the current IEEE TS 23.402 draft, the APN and PDN GW identity/address for all active PDN connections of a UE are stored in HSS. This is to enable preservation of the PDN GW, for each PDN connection at mobility between accesses. When tagged APNs are used, the tag has also to be stored together with the APN and PDN GW identity/address in the Home Subscriber Server (HSS). This may however be made transparent to the HSS if the tagged APNs are stored.

In case of initial attach, the APN is not necessarily provided by the UE. Instead a default APN as provided by the HSS may be used. In order to allow the UE to perform appropriate tagging in this case, the NW should inform the UE about the APN used for initial attach (default APN). Note: the current draft 23.401 already specifies that the NW shall inform the UE about the APN used for the initial attach.

The main advantage of the solution according to the present invention is the avoidance of Network Address Translation (NAT) routing in UEs, and that backwards compatibility with the PDP context concept is enhanced.

Another advantage is that impact on Proxy Mobile IP (PMIP) is avoided. This is an advantage since it may be difficult and/or requiring long lead times to put 3GPP-specific requirements on IETF protocols.

Yet another advantage is that impact on Policy and Charging Control (PCC) architecture for PMIP is avoided. PCC can maintain the possibility to use {UE ID, APN} as session identifier.

As a solution to supporting multiple PDN connections towards one APN in the EPS, the invention has the least impact on the EPS as a whole, and particularly no impact on the protocols used over various mobility reference points (S5/S8, S2a, S2b, S2c) or PCC reference points (Gxx, Gx).

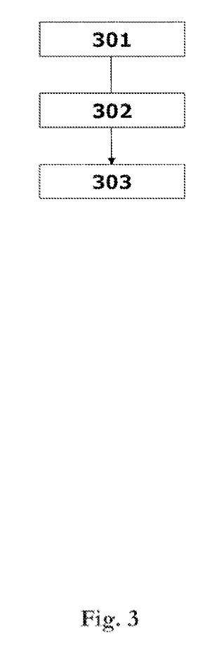

One embodiment for providing a tag to an appropriate node in the network according to the present invention may be shown in relation to FIG. 3:
301. Controlling all active PDN connections;
302. In relation to opening a new PDN connection amending the APN to include a tag for, e.g. a separator and a sequence number;
303. Using the tag for distinguishing connections from each other.

It should be noted that even though the present invention has been exemplified using user equipment and access GW, other entities with similar operational features may be used within the scope of the invention.

The present invention may also be realized as processor readable instructions stored in a processor readable storage medium.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be at least in part implemented by means of both hardware and software, and that several “means” or “units” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

### DEFINITIONS AND ABBREVIATIONS

APN Access Point Name
BSC Base Station Controller
BTF Bearer Translation Function
BTS Base Transceiver Station
DB Database
EPC Evolved Packet Core
EPS Evolved Packet System
E-UTRAN Evolved UTRAN
FA Foreign Agent
GGSN Gateway GPRS Support Node
GPRS General Packet Radio Service
GW Gateway
HSS Home Subscriber Server
IP Internet Protocol
IPCP Internet Protocol Control Protocol
HA Home Agent
HLR Home Location Register
IEEE Institute of Electrical and Electronics Engineers
LTE Long term Evolution
MME Mobility Management Entity
MS Mobile Station
NAS Non-Access Stratum
PCC policy and charging control
PDN Packet Data Network
PDP Packet Data Protocol
PMIP Proxy Mobile IP
PPP Point-to-Point Protocol
QoS Quality of service
RAN Radio Access Network
RAU Routeing Area Update
RNC Radio Network Controller
SGSN Serving GPRS Support Node
TA Tracking Area
TAU Tracking Area Update
TE Terminal Equipment
UE User Equipment
UTRAN UMTS Terrestrial Radio Access Network
VLR Visitor Location Register
WAN Wide Area Network
WLAN Wireless Local Area Network
WPAN Wireless Personal Area Network

### REFERENCES

### Incorporated by Reference into this Document

[1] 3GPP TS 23.401 (draft v 8.0.0): GPRS enhancements for E-UTRAN access
[2] 3GPP TS 23.402 (draft v 8.0.0) Architecture enhancements for non-3GPP accesses
[3] Proxy Mobile IPv6, Internet Draft (draft-letf-netimm-proxymip6-07.txt)

It should be noted that other protocol standards may be used as understood by the skilled person.

1. A communication node for providing multiple Packet Data Network (PDN), connections towards one Access Point Name (APN), in a telecommunications network, comprising:
a processor;
a memory;
a communication interface for communication with the telecommunications network;
wherein the processor is arranged to execute instructions stored in the memory for inserting a tag, associated with a PDN connection, in an access point name string transmitted over the network in an Internet Protocol based communication link, where the tag is arranged to uniquely distinguish the PDN connection from other PDN connections, and
where the tag is further arranged to provide multiple PDN connections towards the one APN.

2. The node according to claim 1, wherein the node is one of a user equipment (UE), a radio network node, or a core network node.

3. The node according to claim 1, wherein the tag comprises a divisor and a unique string of characters.

4. The node according to claim 3, wherein the divisor comprises a semicolon.

5. The node according to claim 3, wherein the unique string of characters comprises a sequence number.

6. The node according to claim 2, wherein the radio network node is arranged to receive a new PDN connection request from a UE and to tag the APN in relation to receiving the new PDN connection request.

7. The node according to claim 2, wherein the UE is arranged to insert the tag in relation to sending a request for a new PDN connection setup.

8. The node according to claim 2, wherein the UE is further arranged with a local communication interface towards external local terminal equipment.

9. The node according to claim 8, wherein the terminal equipment is one of a PDA or a laptop.

10. The node according to claim 2, wherein the radio network node is one of RNC, STS, SSC, or eNodeB.

11. A method for providing multiple Packet Data Network (PDN), connections associated with one Access Point Name (APN), in a telecommunications network, comprising:
including in an APN message a tag for each PDN connection, distinguishing each PDN connection from other PDN connections in an Internet Protocol based communication link, where the tag is arranged to comprise a unique identifier, and
where the tag is further arranged to provide multiple PDN connections towards the one APN.

12. The method according to claim 11, where the unique identifier comprise a serial number.

13. A system handling a plurality of packet data connections in a telecommunications network, comprising:
a communication device comprising a processing unit, a memory unit and at least one communication interface;
at least one terminal equipment in communication with the communication device on the at least one communication interface;
wherein the communication device is arranged to execute instructions stored in a memory for inserting a tag in an access point name string, associated with an established PDN connection, transmitted over the network in an Internet Protocol based communication link and where the tag is arranged to uniquely distinguish the PDN connection from other PDN connections, and where the tag is further arranged to provide multiple PDN connections towards the one APN.

14. An infrastructure node in a telecommunications network, comprising
a processor;
a memory;
a communication interface for communication with the telecommunications network;
wherein the processor is arranged to execute instructions stored in the memory for extracting a unique tag in an access point name (APN) string, associated with a Packet Data Network connection, transmitted over the network in an Internet Protocol based communication link received on the communication interface, where the tag is arranged to distinguish a specific PDN connection from a plurality of Packet Data Network connections associated with the APN, and
where the tag is further arranged to provide multiple PDN connections towards the one APN.
